(19) United States
(12) Patent Application Publication
(10) Pub. No.: US 2018/0322183 A1
(43) Pub. Date: Nov. 8, 2018

(54) SYSTEMS AND METHODS FOR NORMALIZING IDENTITY CLAIMS ACROSS DISPARATE IDENTITY DIRECTORIES

(71) Applicant: Citrix Systems, Inc., Fort Lauderdale, FL (US)

(72) Inventor: Ricardo F. Feijoo, Fort Lauderdale, FL (US)

(21) Appl. No.: 15/585,897

(22) Filed: May 3, 2017

(51) Int. Cl. G06F 17/30

(52) U.S. Cl. CPC G06F 17/30581; G06Q 10/10; G06F 17/3012; G06F 17/30091

(57) ABSTRACT

Systems and methods for normalizing claims across a plurality of disparate identity directories. The methods comprise: receiving, by a computing device, a directory claim from a first identity directory of the plurality of disparate identity directories; transforming, by the computing device, the directory claim into a composite directory claim including at least two of a first normalized claim containing an object identifier (e.g., an Security Identifier (“SID”) or Object Identifier (“OID”)), a second normalized claim containing a system user identifier (e.g., User Principle Claim (“UPN”) or email address), and a third normalized claim containing an entity identifier (e.g., a Globally Unique Identifier (“GUID”)); and causing, by the computing device, at least a portion of the composite directory claim to be used in authorizing use of network resources provided by a relying party, where the network resources are unable to recognize identity information contained in the directory claim.

### BACKGROUND

### Statement of the Technical Field

The present disclosure relates generally to computing systems. More particularly, the present disclosure relates to implementing systems and methods for normalizing identity claims across disparate identity directories.

### Description of the Related Art

There are various conventional software solutions for allowing access to remote desktops, files and applications. For example, these conventional software solutions include Citrix Cloud, XenApp/XenDesktop (“XA/XD”), XenMobile/XM Essentials, ShareFile, and NetScaler Gateway (“NSG”). Each of the listed products has been developed independently and has evolved differently on how it deals with the underlying directory. All except NSG share the problem of supporting Active Directories (“ADs”). It is a large amount of work to support different directories, especially Azure ADs (“AADs”).

In an attempt to “quickly” support AADs each product made different choices, but universally chose to treat Authentication to an AAD different from authorization. That is since the products were built to authorize using an AD, they chose to continue to do this rather than understand native AAD representations of objects. These decisions were facilitated by AAD support for syncing AD attributes to AAD. All teams used the synced attributes to map back to an attribute they already supported shown in the table below.

| Product | Attribute |
|---|---|
| XenApp/XenDesktop/ | AAD SID claim direct |
| Essentials/SecureBrowser | |
| XenMobile/Essentials | UPN: UPN->SID conversion for user Group |
| ShareFile | No support for AAD, need AD GUID |
| Netscaler Gateway | Natively Support AAD OID |

To further exacerbate the problem, products need to support a customer starting with AD, configuring all their authorization, and then upgrading to AAD, without having to re-Authorize all the applications to new entities. Customers expect this behavior because of AAD's ability to sync attributes. To accomplish the above, a customer is forced, or desires, to Authorize using AD concepts even though they want to enable Authentication from AAD.

This is fine for each product individually, but in a cloud based system the administrator jointly authorizes access to applications in a unified User Interface (“UI”). Since different products expect different behavior, this would confuse the administrator. Take the example of configuring NSG applications and XA applications in the same UI. The administrator would have to choose AD objects for XA, but an AAD object for NSG.

### SUMMARY

The present disclosure concerns implementing systems and methods for normalizing claims across a plurality of disparate identity directories. The methods comprise: receiving, by a computing device, a directory claim from a first identity directory of the plurality of disparate identity directories; transforming, by the computing device, the directory claim into a composite directory claim including a plurality of normalized claims. The normalized claims including, but are not limited to, at least two of a normalized claim containing an object identifier (e.g., a Security Identifier (“SID”) or an Object Identifier (“OID”)), a second normalized claim containing a system user identifier (e.g., a User Principle Claim (“UPN”) or email address), and a third normalized claim containing an entity identifier (e.g., an Active Directory Globally Unique Identifier (“ADGUID”)); and causing, by the computing device, at least a portion of the composite directory claim to be used in authorizing use of network resources provided by a relying party, where the network resources are unable to recognize identity information (e.g., a globally unique identifier) contained in the directory claim.

In some scenarios, the first identity directory comprises a multi-company directory into which a single company directory is synchronized. The single company directory is synchronized into the multi-company directory by creating a user entry in the multi-company directory for each user in the single company directory in the context of a respective company.

In those or other scenarios, each of the first, second and third normalized claims includes an identity provider customer identifier. The identifier provider customer identifier is followed by the object identifier (e.g., SID or OID), the system user identifier (e.g., UPN or email address) or entity identifier (e.g., ADGUID). Additionally or alternatively, user login to services provided by the relying party is federated to the first identity directory.

### BRIEF DESCRIPTION OF THE DRAWINGS

Embodiments will be described with reference to the following drawing figures, in which like numerals represent like items throughout the figures.

FIG. 1 is an illustration of an exemplary system.

FIG. 2 is an illustration that is useful for understanding a subscription process in accordance with the present solution.

FIG. 3 provides an illustration that is useful for understanding an authentication and authorization process in accordance with the present solution.

FIGS. 4-5 provide exemplary messaging flows that are useful for understanding an exemplary implementation of the present solution.

FIG. 6 provides an illustration of an exemplary computing device.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

In conventional network based systems, Identity Service Providers (“ISPs”) often use different technologies for Identity Management (“IdM”) or Identity Access Management (“IAM”). An IdM (or IAM) provides a means to allow the right individuals to access the right network resources (e.g., network devices, files, documents, etc.) at the right times and for the right reasons. In this regard, the IdM (or IAM) comprises a module operative to authenticate the identity of users via user credentials (e.g., user names, passwords, security tokens) and authorize user access to network resources based on data describing the information that the user is authorized to access and/or actions that the user are authorized to perform. This utilization of different technologies for IdM (or IAM) purposes provides an undesirable amount of difficulty with regard to system maintenance, configuration and modification.

A barrier to supporting a new IdM (or IAM) technology across a suite of related products is the need to have all the products understand how to interact with each ISP system. Each ISP system has its own IdM (or IAM) schema and methods for communicating objects through claims. The word “claim”, as used herein, refers to any piece of data about a user. The user (in this context) includes, but is not limited to, a software application, a network device, or an end user. A claim can include, but is not limited to, a name, a location, a privilege level, a group association, a device type, or a preference. The unique set of claims for a user constitutes that user's identity within a computing system. These claims are provided to relying parties through an issuing authority (e.g., a Security Token Service (“STS”) for use in authorizing access to resources. Whenever a group of related products wants to support a new IdM (or IAM) technology, each product needs to understand the same and have code added thereto for supporting the new IdM (or IAM) schema.

A barrier to supporting a single-tenant ISP system in a multi-tenant product is making any claims associated with that ISP system globally unique. The multi-tenant product implements a software architecture in which a single instance of software runs on a server and servers multiple tenants. A tenant is a group of users who share a common access with specific privileges to the software instance. The attributes used in the multi-tenant product are not globally unique. Below is a table that adds uniqueness to the attributes each of a plurality of multi-tenant products is using.

| Product | Attribute | Uniqueness |
|---|---|---|
| XenApp/XenDesktop/ | AAD SID claim direct | Customer |
| Essentials/SecureBrowser | | |
| XenMobile/Essentials | UPN: UPN->SID | Customer |
| | conversion for user | |
| | Group | |
| ShareFile | No support for AAD, | Global |
| | need AD GUID | |
| Netscaler Gateway | Natively Support AAD | Global |
| | OID | |

As you can see, there is a need for an anchor to each of the claims that sets customer context because the claims themselves are not globally unique across all customers.

The present solution leverages a central identity system that integrates with each new ISP and normalizes the schema of each individual ISP so that the suite of products only needs to integrate with the normalized schema. In effect, the suite of products are able to instantly support any new ISP added to the central identity system. The central identity system standardizes this by the use of identity plugins that play the role of translator from a new ISP system being added to a common schema agreed to by the suite of products or relying parties. This schema preserves the vital information from each directory and provides a standardized claim set.

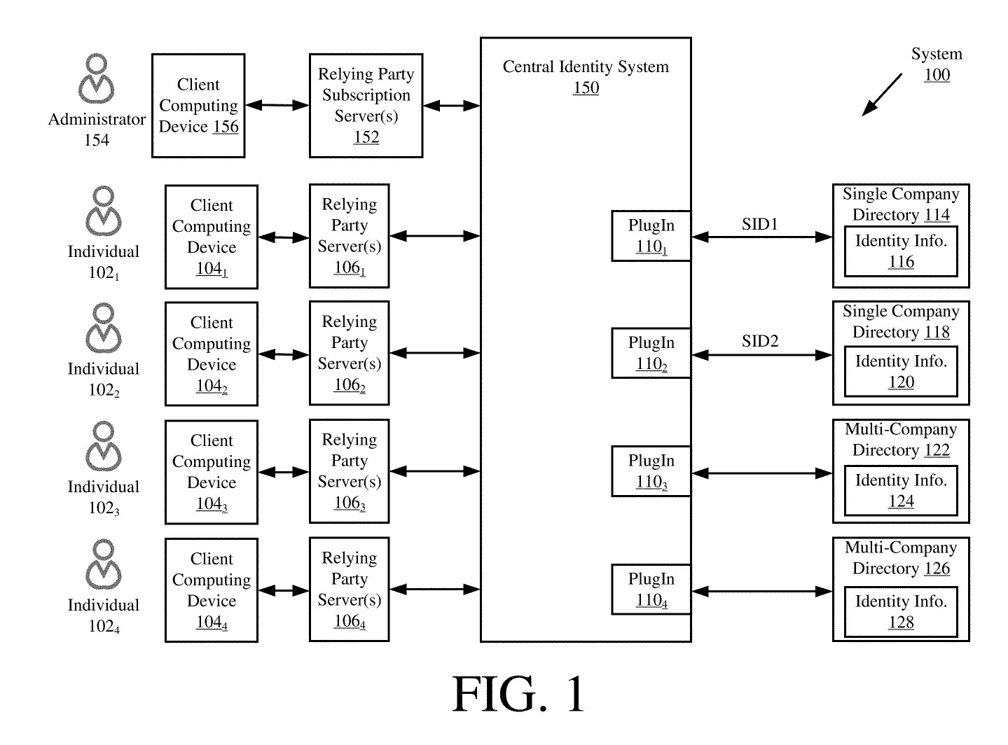

Referring now to FIG. 1, there is provided a schematic illustration of an exemplary system 100. System 100 is generally configured to normalize identity claims across disparate identity directories. A claim is a statement an entity makes about itself in order to establish access to a network resource. In this regard, system 100 comprises a plurality of client computing devices 104₁, 104₂, 104₃, 104₄ being respectively used by individuals 102₁, 102₂, 102₃, 102₄ to access resources hosted by relying party servers 106₁, 106₂, 106₃, 106₄. The client computing devices include, but are not limited to, desktop computers, laptop computers, personal computers, personal digital assistants, smart phones, and/or mobile phones. Each of the listed computing devices is well known in the art, and therefore will not be described herein. The individuals 102₁, 102₂, 102₃, 102₄ are employees of the same company or different companies. The relying party servers provide access to various resources. These resources include, but are not limited to, secure claims-based software applications, web applications, and/or web services.

In order to obtain access to the resources, an authentication process is performed to ensure that only those authorized individuals gain access thereto. This authentication process is implemented via a central identity system 150 and directories 114, 118, 122, 126. The central identity system 150 has different plug-ins 110₁, 110₂, 110₃, 110₄ that communicate with backend directories 114, 118, 122, 126. Each directory is a source of identity information 116, 120, 124, or 128. The directory 114, 118, 122, 126 can be a single company (or tenant) directory or a multi-company (or multi-tenant) directory. Both of these types of directories are well known in the art, and therefore will not be described herein.

In conventional single company directory scenarios, a company may use a Microsoft® Active Directory (“AD”) that is installed locally in a datacenter. The Microsoft®AD comprises a datastore containing identity information exclusively for all of its employees. This identity information comprises employee names, user names, passwords, addresses, phone numbers, managers, and other individual identifying information. The Microsoft®AD also contains information about how individuals in the company can be grouped together (e.g., an accounting group, a legal team, an engineering team, etc.). This identity information is used to allow employees to access resources (e.g., software applications, folders, files, and/or documents) of the company's network (e.g., an Intranet). The present solution is not limited to the particulars of the example.

In a conventional multi-company directory scenario, multiple companies may use the cloud hosted Azure® AD. The Azure® AD comprises a datastore containing identity information for employees of multiple companies. This identity information comprises employee names, user names, passwords, addresses, phone numbers, managers, and other individual identifying information. The Azure® AD also contains information about how individuals in each company can be grouped together (e.g., an accounting group, a legal team, an engineering team, etc.). This identity information is used to allow employees to access resources (e.g., software applications, folders, files, and/or documents) of their respective company's network (e.g., Intranets). The present solution is not limited to the particulars of the example.

The present solution allows employees of companies to use their own identity information to login to a variety of relying party products (e.g., web services hosted by web servers 106₁, 106₂, 106₃, 106₄) which are accessible via the Internet, regardless of whether the identity information is stored in a single company directory or a multi-company directory. In this regard, the employees are able to sign into the relying party products using the identity that the employees use to access the company's network resources, i.e., each employee uses the same user name and password to login to the company's network and to obtain access to relaying party products via the Internet (e.g., web services accessible via a web browser).

During operation, the relying party servers 106₁, 106₂, 106₃, 106₄ count on the central identity system 150 to provide identity information for an individual who has logged in thereto. This identity information includes, but is not limited to, a Security Identifier (“SID”). The SID is a value of variable length used to identify the individual and the individual's group memberships. The SID is used by the relaying party servers to perform various functions (e.g., to grant or deny access and privileges to resources based on access control lists that use SIDs to identify users and the user's group memberships). An issue exists with the use of SIDs in single company (or tenant) directories since the SIDs across two or more companies are not necessarily unique.

For example, let's assume that individuals 102₁ and 102₂ are employees of different companies. Specifically, individual 102₁ is an employee at company A and individual 102₂ is an employee at company B. Each company A and B has its own single company (or tenant) directory for providing identifying information for its employees. The first single company directory 114 is installed at company A's local datacenter, and second single company directory 118 is installed at company B's datacenter. Single company (or tenant) directories are well known in the art, and therefore will not be described herein. In some scenarios, the single company (or tenant) directories include, but are not limited to, Microsoft® ADs.

The identifying information includes SIDS, such as SID1 and SID2. The SIDs ensure that only those authorized individuals 102₁, 102₂ gain access to resources (e.g., licensed software applications, folders, files and/or documents) of company A or B. Each SID in a single company (or tenant) directory uniquely identifies a particular employee within a respective company A or B. Accordingly, SID1 uniquely identifies individual 102₁ from other employees in company A. Similarly, SID2 uniquely identifies individual 102₂ from other employees in company B. However, SID1 and SID2 match each other, and therefore do not uniquely identify individuals 102₁ and 102₂ on a global basis or across companies. This causes issues when both individuals 102₁, 102₂ are using a relying party product (e.g., a web service) hosted by a relying party server 106₁, 106₂, 106₃, or 106₄ (which is an SID based device) since the relying party product assumes that both SIDs are unique.

Accordingly, the present solution standardizes the way that SIDs are defined in system 100 so that they are globally unique even though the SIDs in the single company (or tenant) directories are not necessarily unique across companies, as well as provides a means for synchronizing single company (or tenant) directories into a multi-company (or tenant) directory. The directory synchronization is optional depending on the particulars of given applications.

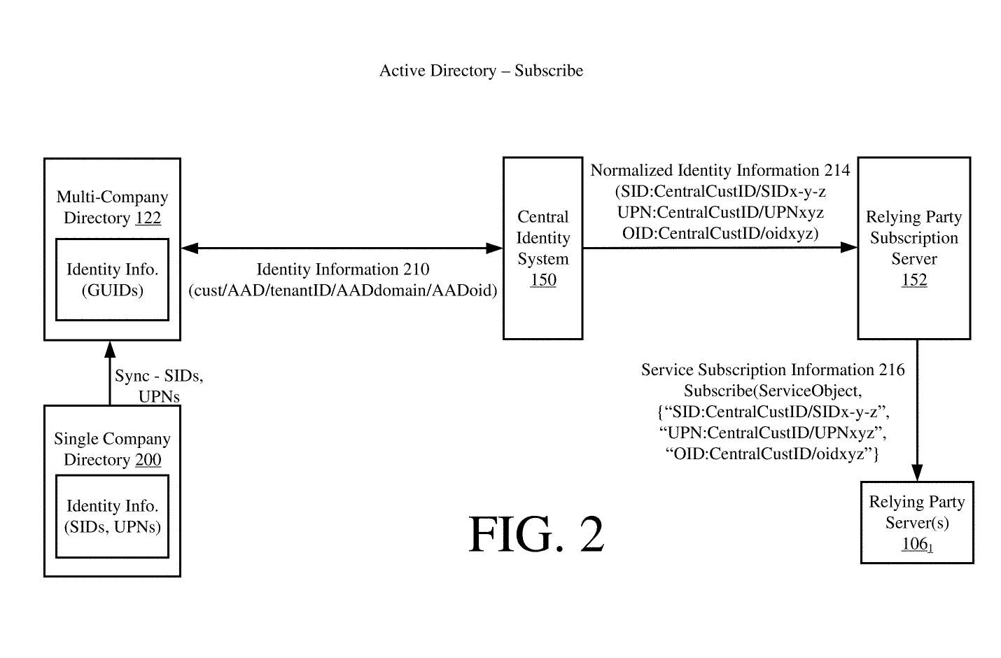

In some scenarios as shown in FIG. 2, the synchronizing is achieved by creating a user in the multi-company directory 122 for each user in the single company directory 200 in the context of the respective company based on the user's associated identifier(s) (e.g., SID and User Principle Name (“UPN”) (e.g., email address)). Notably, multi-company directories are designed so that the identifiers contained therein for each user are Globally Unique IDs (“GUIDs”).

During use, the central identity system 150 communicates with the multi-company directory 122 for obtaining identity information 210 associated with a user of a relying party product hosted by the relying party server. The identity information 210 is defined by the following multi-customer directory claim: cust/AAD/tenantID/AADdomain/AADoid. This multi-customer directory claim indicates that a customer cust (e.g., company A) of a multi-customer active directory AAD (e.g., Azure AD) has an associated customer identifier tenant ID and an employee with an associated GUID AADoid.

The GUID AADoid is not recognized by the relying party server, which is an SID based server configured to operate with the single company directory 200. The relying party server is designed to only recognize the SIDs and/or UPNs. Accordingly, the central identity system 150 normalizes the multi-customer directory claim so that the claim is provided to the relying party server as expected. This normalization involves converting the multi-customer directory claim into a composite directory claim comprising three normalized directory claims: a normalized SID claim; a normalized UPN claim; and a normalized OID claim. The normalized SID claim includes an IdP customer identifier followed by an SID. The normalized UPN claim includes an IdP customer identifier followed by a UPN. The normalized OID claim includes an IdP customer identifier followed by an OID. Examples of the three normalized directory claims are: CentralCustID/SID-x-y-z; CentralCustID/UPNxyz; CentralCustID/oidxyz. If Athena is used as the IdP, then the three normalized directory claims can be re-written as: AthenaCustID/SID-x-y-z; AthenaCustID/UPNxyz; AthenaCustID/oidxyz. Formats for SIDs, UPNs, and OIDs are well known in the art, and therefore will not be described herein.

The three normalized directory claims are then sent from the central identity system 150 to the relying party subscription server 152. In turn, the relying party subscription server 152 forwards the three normalized directory claims to a relying party server 106₁ for service subscription purposes. In effect, the operations of the relying party subscription server 152 and/or relying party server 106₁ do not need to be modified for compatibility with the multi-customer active directory (e.g., Azure AD, Okta directory, Active Directory, PingOne directory, etc.). This normalization scheme allows relying party servers/products to continue to operate as originally designed regardless of the type of identity directory from which identity information for a user is to be obtained.

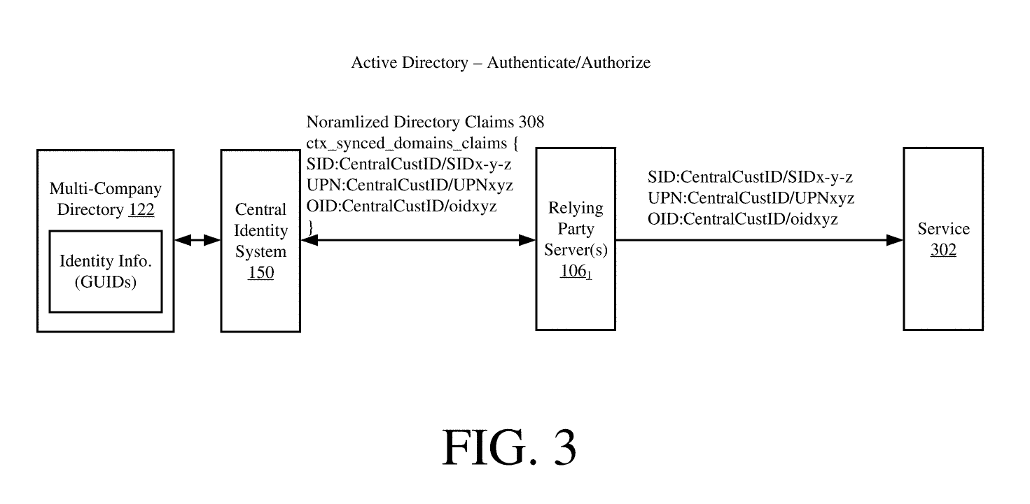

Referring now to FIG. 3, there is provided an illustration that is useful for understanding how the present solution facilitates authentication and authorization. In FIG. 3, a user has requested access and use of a service 302 provided by a relying party via relying party server 106₁. Prior to providing the user access to and use of the service 302, his(her) identity must be authenticated. This authentication is achieved using his(her) user name and password that are the same as those used for obtaining access to his(her) company's (e.g., company A) network (e.g., an Intranet). The relying party server 106₁ performs operations to authenticate the user against the multi-company directory 122 with the user name and password. In this regard, the relying party server 106₁ relies on the central identity system 150 to provide normalized identity information for the user. The central identity system 150 implements the present solution such that it provides the relying party server 106₁ with a token including the three normalized directory claims 308 that match the three normalized directory claims 214 which were previously generated during a subscription process (e.g., the process shown in FIG. 2) for this particular user. In effect, the relying party server 106₁ can now: determine that the user trying to access service 302 is identified as SID-x-y-z, UPNxyz, and/or oidxyz; and confirm that the user is a person who is authorized to use the service 302. Such confirmation is achieved by comparing at least one of the normalized directory claims 308 to the normalized claims contained in the service subscription information 216 previously provided to the relying party server 106₁ during a subscription process (e.g., the subscription process described above in relation to FIG. 2). If a match exists between the claims, then user authorization is confirmed. Once this confirmation is made, the relying party server 106₁ provides authorization to the user to use service 302. The service uses one or more of the three normalized directory claims 214 to perform various functions.

The following hypothetical is provided to assist a reader in understanding the present solution. The present solution is not limited in this regard.

In some hypothetical scenarios, an administrator 154 for company A communicates with a relying party subscription server 152 (e.g., a server of Citrix Cloud) via client computing device 156. This communication indicates that company A would like its employees to have access to a service or resource provided by the relying party (e.g., Microsoft Word hosted by the Citrix Cloud). Accordingly, an account is created for the company via a subscription process. As part of the account creation, three normalized claims for each employee of company A are generated and stored in a memory local or accessible to at least one relaying party server 106₁ , . . . 106_{N}.

Notably, company A does not want the relying party to gain knowledge of employee user names and passwords that will be used to login into a service offered by the relying party. As such, the relying party federates user login to company A's ISP. In this regard, the relying party directs users associated with company A to company A's ISP for login purposes. In effect, the user names and passwords are entered into company A's ISP. Upon a successful user authentication, a token is provided to the central identity system 150. The token includes identifying information for the user that is in a format recognized by company A's ISP. The central identity system 150 processes the claim and transforms it into three normalized directory claims. The normalized directory claims are then provided to the relying party server 106₁ , . . . , 106_{N}. When the resource (e.g., Microsoft Word hosted by the Citrix Cloud) is being launched, the relying party uses at least one of the normalized directory claims to authorize his(her) use of the resource.

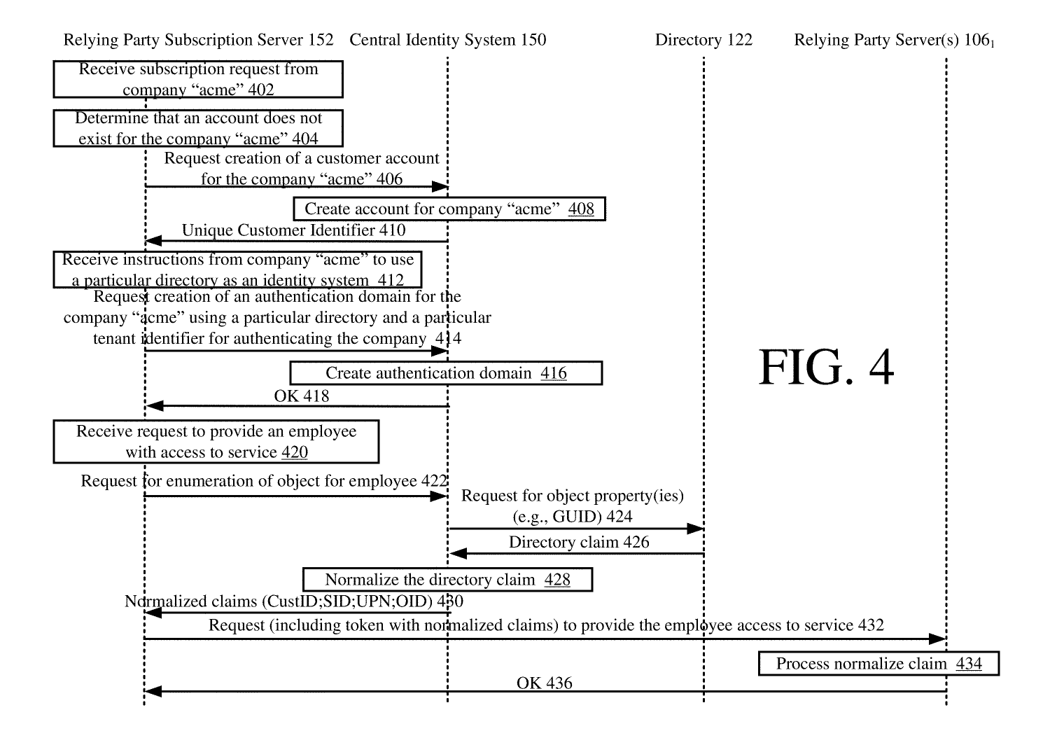

Referring now to FIG. 4, there is provided a messaging flow that is useful for understanding an exemplary implementation of the present solution in a subscription context. As shown in FIG. 4, the relying party subscription server 152 (e.g., Citrix® Cloud) receives a subscription request from a company named “acme”, as shown by block 402. In response to the subscription request, the relying party subscription server 152 performs operations to determine if an account already exists for company “acme”, as shown by block 404. If not, then the relying party subscription server 152 sends a request 406 to the central identity system 150. The request is for the creation of a customer account for the company “acme”. In response to the request, the central identity system 150 creates an account for company “acme”, as shown by block 408. Once the account is created, a unique customer identifier 410 is communicated from the central identity system 150 to the relying party subscription server 152.

Thereafter, the relying party subscription server 152 receives instructions 412 from company “acme” to use a particular directory as an identity system. In response, the relying party subscription server 152 sends a request 414 to the central identity system 150. The request is for the creation of an authentication domain for company “acme” using a particular directory (e.g., multi-customer directory 206) and a particular tenant identifier for authenticating company “acme”. The central identity system 150 creates the requested authentication domain (as shown by block 416) and sends an OK message 418 to the relying party subscription server 152. The OK message notifies the relying party subscription server 152 that the authentication domain was successfully created.

Next as shown by block 420, the relying party subscription server 152 receives a request to provide an employee with access to a service (e.g., service 302 of FIG. 3) or resource. In response to this request, the relying party subscription server 152 sends to the central identity system 150 a request 422 for enumeration of an object for the employee. The objects are users in the directory. Each user has its own object, and each object has properties that were input into the directory. The properties include, but are not limited to, a GUID, an SID, a UPN, and/or an OID.

In turn, the central identity system 150 communicates 424 with a directory 122 for purposes of obtaining a directory claim 426. At the central identity system 150, the directory claim is transformed into a normalized claim 428. For example, the directory claim includes a GUID (e.g., AADoid) and is transformed into three normalized claims SID (e.g., SID:A-CustID/SIDx-y-z), UPN (e.g., UPN:A-CustID/UPNxyz), and OID (e.g., OID:A-CustID/oidxyz). The normalized claims are then communicated from the central identity system 150 to the relying party subscription server 152. In turn, the relying party subscription server 152 communicates a request 432 to a relying party server 106₁ that provides the service. The request includes a token with the normalized claims, and requests that the employee be provided with access to the service. The token is processed at the relying party server 106₁, and an OK message is sent to the relying party subscription server 152.

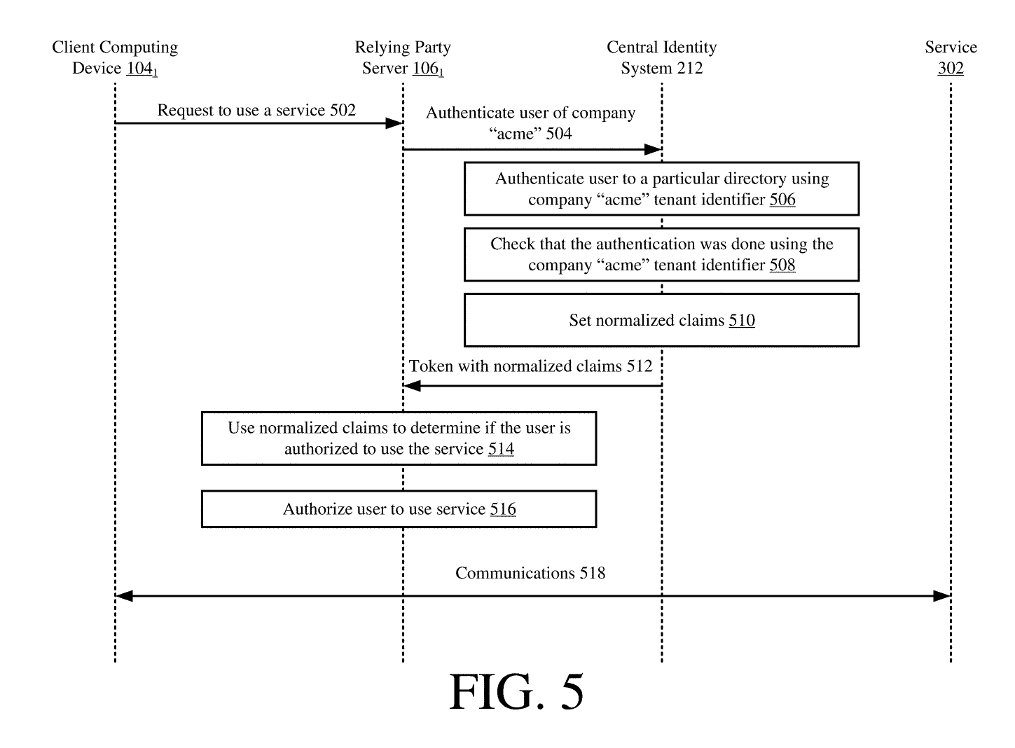

Referring now to FIG. 5, there is provided a messaging flow that is useful for understanding an exemplary implementation of the present solution in an authentication and authorization context. As shown in FIG. 5, a client computing device 104₁ sends a request 502 for use of a service 302 to the relying party server 106₁. In response to the request, the relying party server 106₁ sends a message 504 to the central identity system 212. The message indicates that the user of company “acme” needs to be authenticated. The central identity system 150 then performs operations to authenticate the user to a particular directory (e.g., directory 122) using the company's tenant identifier, as shown by block 506. Upon a successful authentication, the central identity system 150 checks that the authentication was done using the company's tenant identifier, as shown by block 508. Next in block 510, the central identity system 150 sets the normalized claims. A token 512 with the normalized claims is then provided to the relying party server 1066₁. The normalized claims are then used in block 514 to determine if the user is authorized to use the service 302. If so, then the relying party server 106₁ authorizes the user's use of the service, as shown by block 516. During use of the service, communications 518 are made between the client computing device 104₁ and the service 302.

Although the present solution was described above in relation to scenarios in which three normalized claims were generated based on an SID, UPN and OID structure, the present solution is not limited in this regard. The directory claim can be transformed or converted into a composite claim having any number and type of normalized claims selected for a particular application. Generally speaking, the composite claim includes a plurality of normalized claims (e.g., at least two). The normalized claims include, but are not limited to, a first normalized claim containing an object identifier of a first type (e.g., an SID), a second normalized claim containing a system user identifier (e.g., a UPN or email address), a third normalized claim containing an object identifier of a second type (e.g., OID), and/or a fourth normalized claim containing an entity identifier (e.g., an GUID).

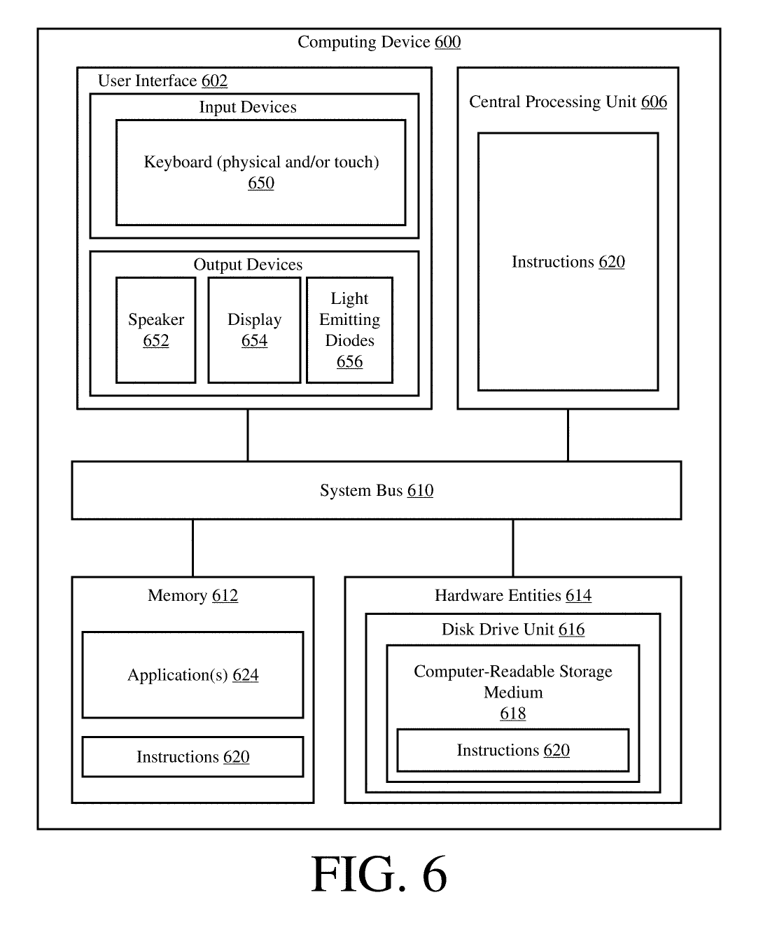

Referring now to FIG. 6, there is provided an illustration of an exemplary architecture for a computing device 600. Computing devices 104₁-104₄, servers 106₁-106₄, 156 and/or central identity system 150 of FIG. 1 (is)are the same as or similar to computing device 600. As such, the discussion of computing device 600 is sufficient for understanding these component sof system 100.

In some scenarios, the present solution is used in a client-server architecture. Accordingly, the computing device architecture shown in FIG. 6 is sufficient for understanding the particulars of client computing devices and servers.

Computing device 600 may include more or less components than those shown in FIG. 6. However, the components shown are sufficient to disclose an illustrative embodiment implementing the present solution. The hardware architecture of FIG. 6 represents one embodiment of a representative computing device configured to enable normalizing identity claims across disparate identity directories as described herein. As such, the computing device 600 of FIG. 6 implements at least a portion of the method(s) described herein.

Some or all the components of the computing device 600 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 6, the computing device 600 comprises a user interface 602, a Central Processing Unit (“CPU”) 606, a system bus 610, a memory 612 connected to and accessible by other portions of computing device 600 through system bus 610, and hardware entities 614 connected to system bus 610. The user interface can include input devices and output devices, which facilitate user-software interactions for controlling operations of the computing device 600. The input devices include, but are not limited, a physical and/or touch keyboard 650. The input devices can be connected to the computing device 600 via a wired or wireless connection (e.g., a Bluetooth® connection). The output devices include, but are not limited to, a speaker 652, a display 654, and/or light emitting diodes 656.

At least some of the hardware entities 614 perform actions involving access to and use of memory 612, which can be a Radom Access Memory (“RAM”), a disk driver and/or a Compact Disc Read Only Memory (“CD-ROM”). Hardware entities 614 can include a disk drive unit 616 comprising a computer-readable storage medium 618 on which is stored one or more sets of instructions 620 (e.g., software code) configured to implement one or more of the methodologies, procedures, or functions described herein. The instructions 320 can also reside, completely or at least partially, within the memory 612 and/or within the CPU 606 during execution thereof by the computing device 600. The memory 612 and the CPU 606 also can constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding or carrying a set of instructions 620 for execution by the computing device 600 and that cause the computing device 600 to perform any one or more of the methodologies of the present disclosure.

In some scenarios, the hardware entities 614 include an electronic circuit (e.g., a processor) programmed for facilitating content sharing amongst users. In this regard, it should be understood that the electronic circuit can access and run application(s) 624 installed on the computing device 600. The functions of the software application(s) 324 are apparent from the above discussion of the present solution. For example, the software application is configured to perform one or more of the operations described above in relation to FIGS. 3-5.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method for normalizing claims across a plurality of disparate identity directories, comprising:
receiving, by a computing device, a directory claim from a first identity directory of the plurality of disparate identity directories;
transforming, by the computing device, the directory claim into a composite directory claim including at two of a first normalized claim containing an object identifier, a second normalized claim containing a system user identifier, a third normalized claim containing an entity identifier; and
causing, by the computing device, at least a portion of the composite directory claim to be used in authorizing use of network resources provided by a relying party, where the network resources are unable to recognize identity information contained in the directory claim.

2. The method according to claim 1, wherein the first identity directory comprises a multi-company directory into which a single company directory is synchronized.

3. The method according to claim 2, wherein the single company directory is synchronized into the multi-company directory by creating a user entry in the multi-company directory for each user in the single company directory in the context of a respective company.

4. The method according to claim 1, wherein the directory claim includes a globally unique identifier that is not recognized by the network resources.

5. The method according to claim 1, wherein each of the first, second and third normalized claims includes an identity provider customer identifier.

6. The method according to claim 1, wherein the identifier provider customer identifier is followed by the object identifier, the system user identifier, or the entity identifier.

7. The method according to claim 1, wherein user login to services provided by the relying party is federated to the first identity directory.

8. A non-transitory computer readable medium storing a program causing a computer to execute a process, the process comprising:
receiving a directory claim from a first identity directory of the plurality of disparate identity directories;
transforming the directory claim into a composite directory claim including at least two of a first normalized claim containing an object identifier, a second normalized claim containing a system user identifier, and a third normalized claim containing an entity identifier; and
causing at least a portion of the composite directory claim to be used in authorizing use of network resources provided by a relying party, where the network resources are unable to recognize identity information contained in the directory claim.

9. The non-transitory computer readable medium according to claim 8, wherein the first identity directory comprises a multi-company directory into which a single company directory is synchronized.

10. The non-transitory computer readable medium according to claim 9, wherein the single company directory is synchronized into the multi-company directory by creating a user entry in the multi-company directory for each user in the single company directory in the context of a respective company.

11. The non-transitory computer readable medium according to claim 8, wherein the directory claim includes a globally unique identifier that is not recognized by the network resources.

12. The non-transitory computer readable medium according to claim 8, wherein each of the first, second and third normalized claims includes an identity provider customer identifier.

13. The non-transitory computer readable medium according to claim 8, wherein the identifier provider customer identifier is followed by the object identifier, the system user identifier, or the entity identifier.

14. The non-transitory computer readable medium according to claim 8, wherein user login to services provided by the relying party is federated to the first identity directory.

15. A system, comprising:
a processor; and
a non-transitory computer-readable storage medium comprising programming instructions that are configured to cause the processor to implement a method for inventory management, wherein the programming instructions comprise instructions to:
receive a directory claim from a first identity directory of the plurality of disparate identity directories;
transform the directory claim into a composite directory claim including at least two of a first normalized claim containing an object identifier, a second normalized claim containing a system user identifier, and a third normalized claim containing an entity identifier; and
cause at least a portion of the composite directory claim to be used in authorizing use of network resources provided by a relying party, where the network resources are unable to recognize identity information contained in the directory claim.

16. The system according to claim 15, wherein the first identity directory comprises a multi-company directory into which a single company directory is synchronized.

17. The system according to claim 16, wherein the single company directory is synchronized into the multi-company directory by creating a user entry in the multi-company directory for each user in the single company directory in the context of a respective company.

18. The system according to claim 15, wherein the directory claim includes a globally unique identifier that is not recognized by the network resources.

19. The system according to claim 15, wherein each of the first, second and third normalized claims includes an identity provider customer identifier.

20. The system according to claim 15, wherein user login to services provided by the relying party is federated to the first identity directory.
